(19) United States
(12) Patent Application Publication
(10) Pub. No.: US 2005/0163615 A1
(43) Pub. Date: Jul. 28, 2005

(54) Redundant fan system in a turbo cooler assembly

(76) Inventors: Sachin Navin Chheda, Roseville, CA (US); Robert W. Dobbs, Granite Bay, CA (US); Ricardo Ernesto Espinoza, Lincoln, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/764,181

(22) Filed: Jan. 23, 2004

(51) Int. Cl. F03D 1/00

(52) U.S. Cl. 416/31

(57) ABSTRACT

In one embodiment, the present invention recites a fan cooling system with high availability comprising a first fan coupled with a first motor for creating a first air flow. A second fan is coupled with a second fan motor for creating a second air flow. A duct system conducts the first air flow and the second air flow to at least one heat sink. A control system is coupled with the first fan motor and the second fan motor.

### TECHNICAL FIELD

Embodiments of the present invention relate to a method and apparatus for increasing the availability of a fan system in a turbo cooler assembly using redundant drive motors. BACKGROUND ART

High-speed integrated circuit (IC) microprocessors used as the central processing unit (CPU) in an electronic system consume power in proportion to their clock speed, and this consumed power must be dissipated away from the IC in order to prevent overheating and consequent IC failures.

Such IC microprocessors form the backbone for many specialized equipment including servers and cellular communications and switching systems where space is severely constrained. Turbo coolers are cooling systems designed specifically to cool a point source of heat such as a microprocessor chip. They are effective in providing a cooling solution in space-constrained environments where air channels are scarce. The turbo cooler consists of a specialized heat sink with a multiplicity of fins to conduct heat from a microprocessor chip to a nearby region, where the second part of the turbo cooler, a fan, blows cooling air past the fins to move the heat from the fins to the surrounding air stream. The heated air exits the enclosure via exhaust vents, thus conducting heat away from the microprocessor chip. Typically, the fan blows cooling air into the enclosure, and the cooling air stream serves all the sources of heat in the interior of the enclosure.

Unfortunately, the fan can be a single point source of failure, since when the turbo cooler fan fails, the effective cooling of the passive system (e.g., the fins), is almost nil, as there is insufficient cooling air flow to conduct heat away from the fins. Under a fan failure in such a system, the CPU/microprocessor chip can quickly reach a critical temperature whereby serious performance loss ensues due to CPU throttling, data corruption, and/or thermal failure may occur.

### DISCLOSURE OF THE INVENTION

In one embodiment, the present invention recites a fan cooling system with high availability comprising a first fan coupled with a first motor for creating a first air flow. A second fan is coupled with a second fan motor for creating a second air flow. A duct system conducts the first air flow and the second air flow to at least one heat sink. A control system is coupled with the first fan motor and the second fan motor.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 shows a redundant fan system in a turbo cooler assembly in accordance with embodiments of the present invention.

FIG. 2 is a schematic diagram of a control system 200 for a redundant fan system used in accordance with embodiments of the present invention.

FIG. 3 shows another embodiment of a redundant fan system having a pair of co-axially configured fans in accordance with embodiments of the present invention.

FIG. 4 is a flow chart of a method for controlling a redundant fan system in accordance with embodiments of the present invention.

FIG. 5 is a flow chart of a method for providing redundant availability in a fan system in accordance with embodiments of the present invention.

### MODES FOR CARRYING OUT THE INVENTION

Reference will now be made in detail to embodiments of the present invention. While the invention will be described in conjunction with the following embodiments, it will be understood that they are not intended to limit the invention to these embodiments alone. On the contrary, the invention is intended to cover alternatives, modifications and equivalents as defined by the appended claims. Furthermore, in the following detailed description of the present invention, numerous specific details are set forth in order to provide a thorough understanding of the present invention. However, it will be recognized by one skilled in the art that the present invention may be practiced without these specific details. In other instances, well known methods, procedures, components, and circuits have not been described in detail as to avoid unnecessarily obscuring aspects of the present invention.

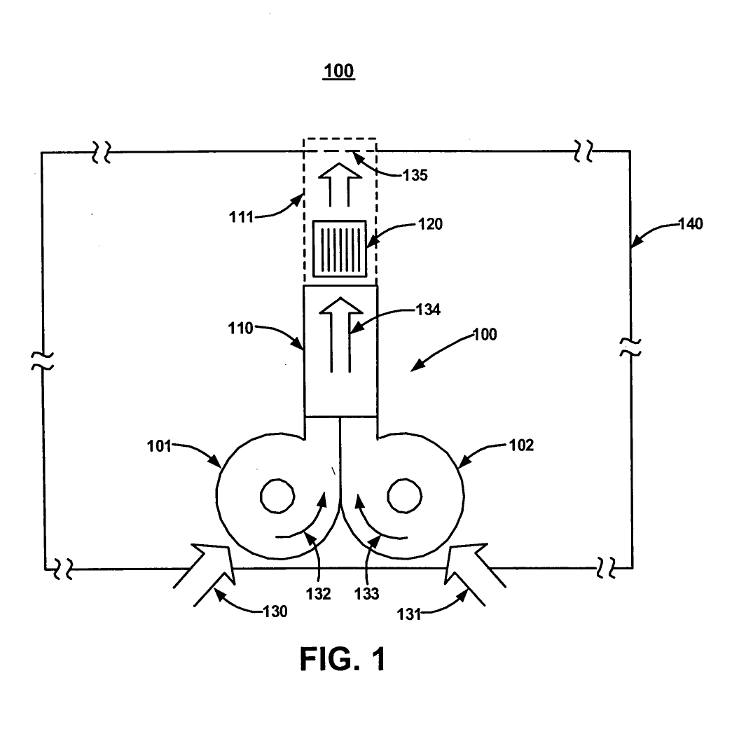

FIG. 1 shows an embodiment of a redundant fan system 100 in a turbo cooler assembly in accordance with embodiments of the present invention. In FIG. 1, a pair of fans 101, 102, are located in proximity to two sources of outside air 130, 131 via vents in the enclosure 140. The fans are configured so that the outside air 130, 131 is impelled within the fan along respective paths 132, 133 by a duct system 110 which conveys the air flow 134 to the heat sink 120 mounted on the microprocessor, where the fins form part of a standard turbo cooler. Because the fins are mounted in the path of air flow 134, the fins of heat sink 120 transfer heat to air flow 134. The heat is then conducted away from heat sink 120 by the moving air and dispersed throughout the interior of enclosure 140, ultimately exiting enclosure 140 and taking the heat with it. Optionally, duct system 110, or a part of it, can be extended beyond the heat sink, as shown at 111, to directly convey the now-heated air stream to an exhaust port out of enclosure 140 via an exhaust port 135. Additionally, duct system 110 may be configured with small holes along its length to disperse some of the air stream into the rest of enclosure 140 to provide air for cooling other components disposed within enclosure 140. Furthermore, duct system 110 may be split into multiple smaller ducts following additional paths to direct cooling air to more than one heat sink, or to other components that require cooling air. In embodiments of the present invention, the heated air stream is exhausted from a region of enclosure 140 away from the front of enclosure 140, thus preventing the heated air stream from easily mixing with outside air 130 and 131.

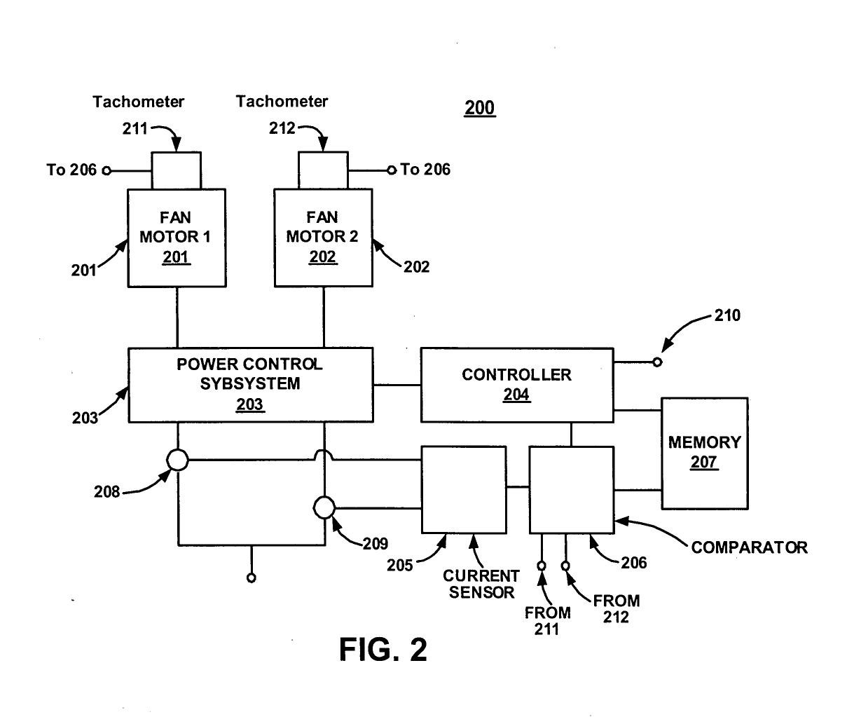

In one embodiment, fans 101 and 102 shown in FIG. 1 are squirrel-cage type fans, but may be realized with any suitable fan type such as one with blades as well. Fans 101 and 102 may be mounted at any suitable location in enclosure 140, and an additional air duct (not shown) may be provided to convey outside air 130 and 131 directly to the fans. In a preferred embodiment, fans 101 and 102 and fan motors (e.g., fan motors 201 and 202 respectively of FIG. 2) driving the fans are mounted near an outer edge of enclosure 140 so that they can be removed as necessary without taking the electronics package out of a rack, or taking any cover off the electronics package, hence providing for easy fan servicing.

In embodiments of the present invention, the fan motors driving fans 101 and 102 are removably coupleable from turbo cooling system 100. As a result, the electronic system being cooled by the fan system may continue operating while a failed fan motor is replaced. In embodiments of the present invention, the fan motor shafts coupling fans 101 and 102 with their respective fan motors are configured so that a fan motor may be removed from its connection to the fan system as it is being removed from the housing that supports the fan motor and the fan itself. Alternatively, the fan motor and its respective fan may be removed as a single unit from the cooling system. In embodiments of the present invention, the fan motor power wires are equipped with quick-disconnect connectors, or other suitable connectors that facilitate fast and easy removal and replacement.

In embodiments of the present invention, the fan motors are configured so that they each can be operated at varying speeds, by changing the voltage level supplied to them. This makes it possible to operate the two fans each at a reduced speed, thereby increasing their expected lifetimes, while still delivering sufficient air flow across heat sink 120 to provide the necessary cooling. In the event of a fan motor failure in one of the fans (e.g., fan 101), the other fan (e.g., fan 102) can be speeded up to compensate for the loss in air flow caused by the failed fan. In other embodiments of the present invention, fans 101 and 102 are driven by alternating current (AC). In some AC fans, additional windings are built into the fan motor which can be selectively engaged to increase/decrease the speed at which the motor operates. In embodiments of the present invention, in the event of a fan motor failure in on of the fans (e.g., fan 101), the additional windings in the other fan (e.g., fan 102) are engaged to increase the speed of the fan motor, thus compensating for the loss in air flow caused by the failed fan.

FIG. 2 is a schematic diagram of a control system 200 for a redundant fan system used in accordance with embodiments of the present invention. In embodiments of the present invention, fan motors 201 and 202 are controlled by varying the voltage made available to them by the power control subsystem 203. In one embodiment, the voltage source is direct current, but could be alternating current as well. In embodiments of the present invention, a microprocessor-based controller 204 initiates supplying power to fan motors 201 and 202 upon main power on, monitoring of fan motor condition, initiation of a change of operating condition from a normal state to a new operating state upon detection of a parameter change that exceeds a specified threshold, and delivery of status condition reports to a local area network node via connection 210.

In embodiments of the present invention, fan motor condition is monitored by tachometers 211, 212, which measure fan speed or fan motor speed for each of the two fan/fan motors and/ or an current measuring device 205 with sensors 208, 209, which measures fan motor current consumption for each fan motor. In one embodiment, current measuring device 205 comprises an ammeter. Such data may be delivered continuously or periodically, upon command from the comparator 206. Normal operating parameters for fan speed or fan motor speed and for current consumption are known based on either measurements or data supplied by the vendor, and are stored in memory 207. Either or parameters both may be used to determine when a performance threshold parameter has been exceeded. For example, consider a fan motor with a nominal fan speed of 500 rpm and a fan current consumption of 100 milliamps (ma.) If the fan motor is failing, the current drawn may increase and the fan speed may decrease. Alternatively, the fan current drawn decrease and the fan speed may decrease as the unit fails. In embodiments of the present invention, a change in either parameter, once the change exceeds a specified level, as determined by comparator 206, may be designated as a trigger condition. In embodiments of the present invention, detection of a trigger condition causes controller 204 to initiate a sub-routine, stored in memory 207, to dynamically initiate a change of operating condition of the remaining fan motor.

In one embodiment, such a change in operating condition, as detected by comparator 206, is indicated to controller 204 which dynamically initiates a command to the power control subsystem to turn off power to the failing motor (e.g., fan motor 201). A second command is also sent to power control subsystem 203 to increase the voltage and therefore the power to the remaining fan (e.g., fan motor 202), to compensate for the loss of power and reduction in air flow from the failing fan motor.

The microprocessor controller 204 generates instructions to comparator 206 to monitor performance data from tachometers 211 and 212 and/or from current measuring device 206 and to compare the performance data fan motor parameters at a rate sufficient to detect a failed fan motor or the impending failure of a fan motor. In embodiments of the present invention, this measurement rate is in the range from 0.1 second to 10 seconds.

In another embodiment of the present invention, controller 204 and memory 207 may be replace with a state machine (not shown) which initiates a fixed response for controlling the fans when a trigger condition is detected. For example, when one fan fails, the state machine automatically causes the other fan to increase speed to compensate for the reduction in air flow from the failed motor.

The method of providing two fans, a common duct for directing the airflow from the two fans, and monitoring their performance may be extended to multiple fans, as the need arises. For some systems, three or more fans and fan motors may be desirable to achieve a specified level of reliability. In such a case, additional performance metrics indicating a type of threshold condition warranting a trigger event and action to turn off a failing fan and change speed on the remaining fans may be developed to deal with multiple failures of such a plurality of fans.

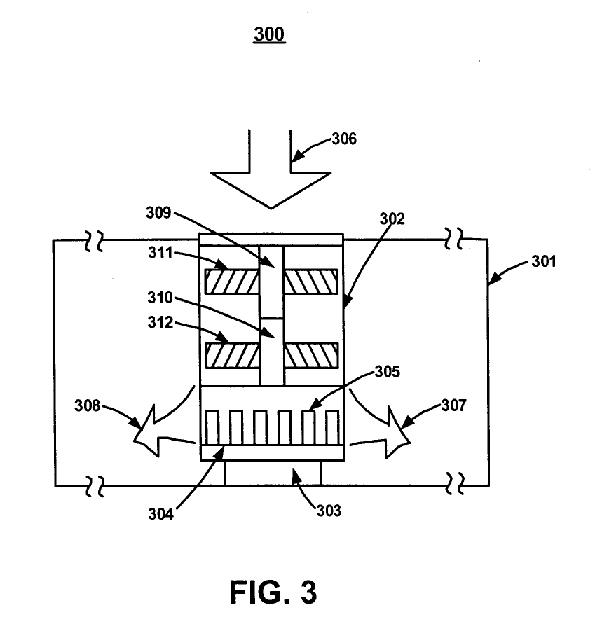

FIG. 3 shows another embodiment of a redundant fan system 300 having a pair of co-axially configured fans in accordance with embodiments of the present invention. In FIG. 3, two fans 311, 312 are disposed in a duct system 302 co-axially, pulling outside air at 306 in tandem from a port on the top of the enclosure 301 across the fins of the heat sink 305, attached to the top of the microprocessor IC 303 via a fin support 304. The fan assembly and duct 302 may be oriented in a horizontal plane, starting at the rear of the enclosure as well, and duct 302 may be directed horizontally instead of vertically. The heated air leaves the region of the turbo cooler fins at 307, 308, and may pass over other elements of the electronics, and out of enclosure 301. The fan motors 309, 310, are also mounted co-axially. In FIG. 3, the blades of fans 311 and 312 are configured so that an inactive fan (e.g., fan 311), caused by a failure of either fan motor 309 or the fan blade, will not impede the flow of air from fan 312. In one embodiment, this is done by reducing the number of blades on fans 311 and 312. If the number of blades on the fans is reduced, the surface area of the remaining blades may be increased to provide greater air flow. In another embodiment, fans 311 and 312 have reversed pitch fan blades, such as counter-rotating fans, so that a stalled fan's blades are parallel to the working fan's airflow. It is appreciated that control system 200 may be used to control redundant fan system 300 in embodiments of the present invention.

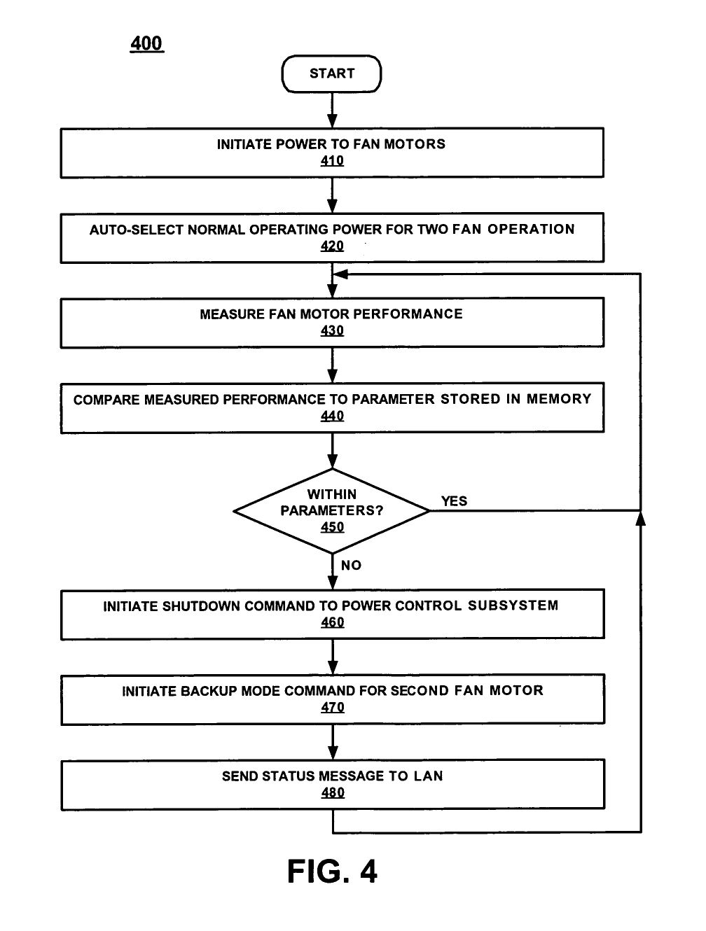

FIG. 4 is a flow chart of a method 400 for controlling a redundant fan system in accordance with embodiments of the present invention. In step 410 of FIG. 4, power is initiated to the fan motors.

In step 420 of FIG. 4, normal operating power for the fan motors is auto-selected. In embodiments of the present invention, controller 204 turns on in a cold start mode, which in turn powers on fan motors 201 and 202 via power control subsystem 203, at a predetermined operating condition for each motor. In one embodiment, the operating condition is half speed for both fans, thus producing the airflow of a single fan operating at its rated full output, but operating each of fan motors 201 and 202 at half power. This is advantageous because the effective operating life of fan motors 201 and 202 can be extended by operating them at less than their full power rating.

In step 430 of FIG. 4, fan motor performance is measured. In embodiments of the present invention, after a short period to allow for fan motors 201 and 202 to come up to operating speed, controller 204 generates commands to comparator 206 to begin monitoring the performance of fan motors 201 and 202. In embodiments of the present invention, comparator 206 collects performance metrics from fan motors 201 and 202.

In step 440 of FIG. 4, the measured performance of the fan motors is compared with parameters stored in memory. In embodiments of the present invention, controller 204 generates commands to comparator 206 to compare the performance metrics from tachometers 211 and 212 and/or current measuring device 205 for each motor with pre-determined performance parameters. In embodiments of the present invention, the pre-determined performance parameters are stored in memory 207. Controller 204 continues to generate commands to comparator 206 to continue making periodic comparisons according to a pre-determined rate. In embodiments of the present invention, the periodic comparisons are performed at a rate in the range from once very 0.1 second to once every 10 seconds. While the present embodiment recites this range of periodic comparisons specifically, it is appreciated that other rates may be used in embodiments of the present invention according to the needs of the system.

In step 450 of FIG. 4, a logical operation is performed to determine whether the measured fan motor performance is within the stored performance parameters. In embodiments of the present invention, if the collected performance metrics are within the pre-determined parameters for fan motor performance, controller 204 waits until the next time period elapses before initiating another comparison and flowchart 400 proceeds to operation 430. If a fan motor performance is found to exceed one of the pre-determined parameters, controller 204 recognizes this event as a trigger event and flowchart 400 proceeds to operation 460

In step 460 of FIG. 4, a shutdown command to the power control subsystem is initiated. In embodiments of the present invention, controller 204 generates a command to power control subsystem 203 which initiates shutting down the failing motor (e.g., fan motor 201).

In step 470 of FIG. 4, a backup mode command for the second fan motor is initiated. In embodiments of the present invention, controller 204 instructs power control subsystem 203 to increase the voltage to the remaining operative motor (e.g., fan motor 202), thereby increasing the fan speed to compensate for the loss due to the failure and de-activation of fan motor 201. In another embodiment, the increase in voltage to fan motor 202 is initiated automatically in response to shutting down the power to fan motor 201.

In step 480 of FIG. 4, a status message is sent to the LAN. In embodiments of the present invention, controller 204 sends a message to a designated address via connection 210 to a Local Area Network, indicating that fan motor 201 has failed and has been de-activated. This message may be conveyed to a monitoring system where it can be brought to the attention of a maintenance activity.

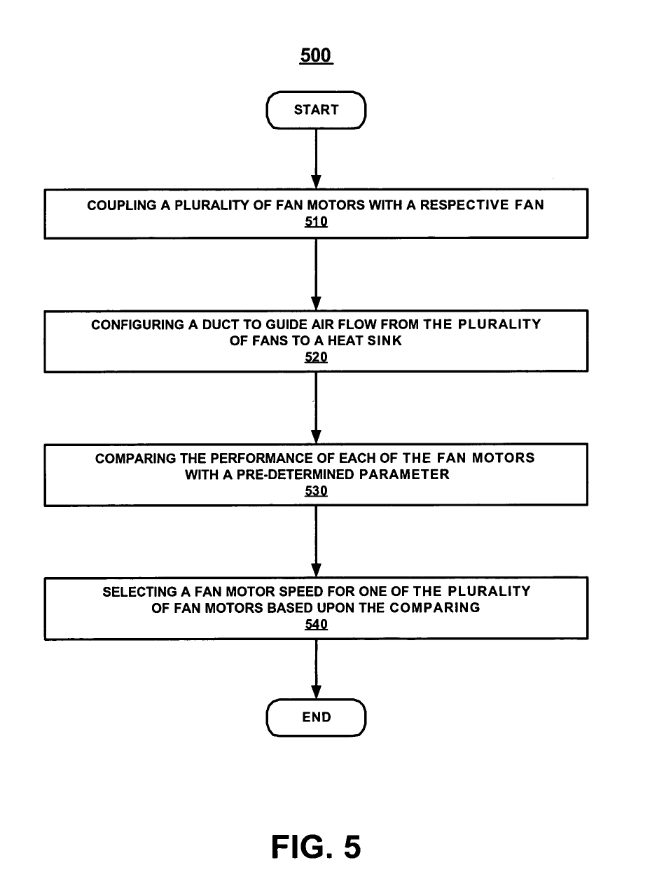

FIG. 5 is a flowchart of a method 500 for providing redundant availability in a fan system in accordance with embodiments of the present invention. In step 510 of FIG. 5, a plurality of fan motors are coupled with respective fans. As discussed above with reference to FIGS. 1-3, fans 101 and 102 may be coupled with fan motors 201 and 202 respectively. Similarly, fans 311 and 312 are coupled with fan motors 309 and 310 respectively.

In step 520 of FIG. 5, a duct is configured to guide air flow from the plurality of fans to a heat sink. In the embodiment of FIG. 1, air flow 134 is directed from fans 101 and 102 to heat sink 120. In the embodiment of FIG. 3, air flow is directed by duct 302 to a heat sink 305.

In step 530 of FIG. 5, the performance of each of the fan motors is compared with a pre-determined parameter. As discussed above with reference to FIG. 2, comparator 206 receives performance metrics from fan motors 201 and 202. In embodiments of the present invention, the performance metrics may be collected from tachometers 211 an 212 and/or current measuring device 205. In embodiments of the present invention, the performance metrics are compared with pre-determined parameters stored in memory 207.

In step 540 of FIG. 5, a fan motor speed is selected for one of the remaining fan motors based upon the comparing of step 530. In embodiments of the present invention, in response to detecting a trigger event (e.g., failure or impending failure of fan motor 101), controller 204 generates commands to power control subsystem 203 to shut down power to fan motor 101 and to increase power to the remaining fan motor (e.g., fan motor 102). As a result of the increased power, fan motor 102 will increase speed to compensate for the loss of fan motor 101.

Various embodiments of the present invention, a redundant fan system in a turbo cooler assembly, are thus described. While the present invention has been described in particular embodiments, it should be appreciated that the present invention should not be construed as limited by such embodiments, but rather construed according to the following claims.

1. A fan cooling system with high availability comprising:
a first fan coupled with a first motor for creating a first air flow;
a second fan coupled with a second motor for creating a second air flow;
a duct system for conveying said first air flow and said second air flow to at least one heat sink; and
a control system coupled with said first fan motor and said second fan motor.

2. The fan cooling system of claim 1 wherein said first motor and said second motor are removably coupleable with said fan cooling system.

3. The fan cooling system of claim 1 wherein said first motor and said second motor are configured to operate at variable speeds.

4. The fan cooling system of claim 1 wherein said control system further comprises:
a motor performance monitoring unit configured to determine a performance metric of said first motor and a performance metric of said second motor.

5. The fan cooling system of claim 4 wherein said motor performance monitoring unit comprises:
a first tachometer configured to determine the rotational speed of said first motor; and
a second tachometer configured to determine the rotational speed of said second motor.

6. The fan cooling system of claim 4 wherein said motor performance monitoring unit comprises:
a current monitoring device for determining the amount of current used by said first motor; and
a second current monitoring device for determining the amount of current used by said second motor.

7. The fan cooling system of claim 4 wherein said motor performance monitoring unit comprises:
a comparator for comparing a measured performance metric of said first motor with a pre-defined parameter and for comparing a measured performance metric of said second motor with a pre-defined parameter.

8. The fan cooling system of claim 7 wherein said motor performance monitoring unit further comprises:
a power control subsystem; and
a controller coupled with said power control subsystem and configured to generate a command to said power control subsystem in response to a signal from said comparator.

9. The fan cooling system of claim 8 wherein said controller causes said power control subsystem to dynamically alter the operating speed of said second fan when said performance metric of said first motor exceeds said pre-defined parameter.

10. The fan cooling system of claim 4 wherein said motor performance monitoring unit comprises:
a state machine for determining when said performance metric of said first motor exceeds a pre-defined parameter and for automatically generating a command to a power control subsystem to dynamically alter the operating speed of said second fan.

11. A redundant fan cooling system comprising:
a plurality of variable-speed fan motors removably coupleable with said redundant fan cooling system;
a plurality of fans, each of said plurality of fans coupled respectively with one of said plurality of variable-speed fan motors;
a ducting system for conveying air flow from each of said fans to a heat dissipating device; and
a controller for dynamically changing the operating speed of at least one of said plurality of variable-speed fan motors in response to a measured performance metric.

12. The redundant fan cooling system of claim 11 wherein said controller further comprises:
a monitoring unit configured to determine a performance metric of each of said plurality of variable-speed fan motors.

13. The redundant fan cooling system of claim 12 wherein said monitoring unit comprises:
a current monitoring device for monitoring the amount of current used by each of said plurality of fan motors.

14. The redundant fan cooling system of claim 12 wherein said monitoring unit comprises:
a tachometer to monitor the rotational speed of each of said plurality of variable-speed fan motors.

15. The redundant fan cooling system of claim 11 wherein said controller further comprises:
a comparator for comparing said measured performance metric with a pre-defined parameter.

16. The redundant fan cooling system of claim 15 wherein said controller dynamically changes the operating speed of said at least one of said plurality of variable-speed fan motors when said measured performance metric exceeds said pre-defined parameter.

17. The redundant fan cooling system of claim 11 wherein said controller further comprises:
a state machine for determining said measured performance metric exceeds a pre-defined parameter and for automatically generating a command to a power control subsystem to dynamically alter the operating speed of said second fan.

18. A method for providing redundant availability in a fan system comprising:
coupling each of a plurality of fan motors with a respective fan;
configuring a duct to guide air flow from said plurality of fans to a heat sink;
comparing the performance of each of said plurality of fan motors with a pre-defined parameter; and
selecting a fan motor speed for one of said plurality of fan motors based upon said comparing.

19. The method as recited in claim 18 further comprising:
receiving a measured performance metric from a monitoring device; and using a comparator to compare said measured performance metric with said pre-defined parameter.

20. The method as recited in claim 19 wherein said monitoring device comprises:
a current monitoring device for monitoring the amount of current used by each of said plurality of fan motors.

21. The method as recited in claim 19 wherein said monitoring device comprises:
a tachometer to monitor the rotational speed of each of said plurality of fan motors.

22. The method as recited in claim 18 further comprising:
operating each of said plurality of fan motors at a first operating speed;
determining that the performance of a first fan motor of said plurality of fan motors exceeds said pre-defined parameter;
disengaging said first fan motor; and
changing the operating speed of a second fan motor of said plurality of fan motors to a second operating speed.
